(19) United States
(12) Patent Application Publication
(10) Pub. No.: US 2026/0074791 A1
(43) Pub. Date: Mar. 12, 2026

(54) COMMUNICATION NETWORK NODE, OPTICAL RF HOLOGRAPHIC BEAM FORMING NETWORK, COMMUNICATION NETWORK AND METHOD OF TRANSMITTING AN RF SIGNAL

(71) Applicant: Telefonaktiebolaget LM Ericsson (publ), Stockholm (SE)

(72) Inventors: Alessandra Bigongiari, Pisa (IT); Filippo Ponzini, Pisa (IT)

(21) Appl. No.: 19/108,061

(22) PCT Filed: Aug. 31, 2022
(86) PCT No.: PCT/EP2022/074246

§ 371 Date: Feb. 28, 2025

(51) Int. Cl. H04B 10/2575; G02B 6/02; H01Q 3/26

(52) U.S. Cl. CPC H04B 10/2575; G02B 6/02195; H01Q 3/2676; H04B 2210/006

(57) ABSTRACT

A communication network node (100) comprising: an antenna array (104) comprising a plurality of radiating elements (106); a plurality of photodiodes (108) connected to the radiating elements; an optical delay line (110) configured to receive an optical carrier signal modulated with an RF signal; and a plurality of optical splitters (112) provided along the optical delay line, the optical splitters configured to split off portions of the optical carrier signal to form a plurality of optical output signals and to deliver the optical output signals to the photodiodes. The photodiodes are configured to recover respective portions of the RF signal from the optical output signals and to deliver said portions of the RF signal to the radiating elements. The optical delay line is configured to time delay the optical carrier signal between variable optical splitters to phase shift the RF signal.

### TECHNICAL FIELD

The invention relates to a communication network node and to a communication network. The invention further relates to an optical radio frequency, RF, holographic beam forming network. The invention further relates to a method of transmitting an RF signal.

### BACKGROUND

Beam forming is a radio transmission technique that allows signal power to be focused at the intended receiver. This is achieved via a variation of the phase and amplitude of the signals transmitted by an array of radiating elements, so that some of the signal experience constructive interference while others experience destructive interference. Beam forming can be used to improve channel performance in a communication network by suppressing multipath components that cause interference and noise can be reduced by minimizing the angular field of view.

Dynamic beam forming allows a mobile communication network operator to manipulate the transmitted RF radiation pattern, and then the beam radio coverage, in azimuth, elevation, and gain and to reposition it electronically. High-speed beam steering also benefits backhaul and fronthaul applications, including fixed broadband wireless, by obviating the need for precise and high-cost alignment procedures.

There are different approaches to the beam forming, that may be categorized as analog, digital, and hybrid. In analog solutions, each antenna element has dedicated analog circuitry consisting of a phase shifter and amplification stage. A common digital radio signal is used for all the antenna elements, which apply proper phase and amplitude corrections for beam forming shaping and steering. The receiver sums up the phase shifted signals received from each antenna element in a single analog signal. For the digital solution, the phase and amplitude of RF signals are processed digitally in the digital baseband. Each antenna element is fed by a dedicated digital signal, that is converted in the analog domain via a DAC. At the receiver, signals are processed by an ADC circuitry, having the capability to process all the data from different antenna elements in parallel, then they are regenerated digitally and summed up in digital baseband. Hybrid beam forming may be defined as where the array is partitioned into multiple sub arrays and each sub-array has its own digital radio signal, but within the same sub-array analog beam forming is used.

Holographic beam forming is a recent beam forming technique using Software Defined Antennas (SDAs) that employs a dynamic beam forming architecture, as reported by Eric Black et al, “Breaking Down mmWave Barriers with Holographic Beam Forming”, Microwave Journal, 12 Feb. 202. Despite being an analog beam forming method, it is substantially different from conventional phased arrays or multiple input multiple output, MIMO, systems. Holographic beam forming systems are passive electronically steered antennas that do not use discrete phase shifters to accomplish beam steering. Instead, beam forming is performed through a change in phase based on true time delay, TTD, and reconfigurable amplitude of the transmitted beam, to form a smooth and highly specific pattern called a “hologram”. The technology that is used in RF Holographic beam forming to control both the phase and amplitude of the hologram is based on an antenna array that has a single RF input which is directly connected to an RF distribution network. A travelling RF wave, named ‘Reference wave’, propagates through the distribution network. This travelling wave will be transformed into a specific beam pattern that may be referred as the ‘Object Wave’. The transfer of energy from the Reference wave to the Object wave is achieved by coupling a set of antenna radiating elements to the distribution network via a set of varactors, that are operable to vary the amount of energy transferred to each radiating element, hence varying the amplitude of the Object wave at that position. This is a different operating mode than a traditional phased array.

At present the method used for phase shifting in the holographic beam forming is based on a plurality of radiating elements, some of which may be used or not depending on the phase shift that must be implemented. In fact, the phase shift is obtained via a time delay that is set between the radiating elements, since they are located at different positions and the Reference wave reaches them at different times. The distance between the radiating elements is then selected by activating just the radiating element that correspond to the desired phase shift, via the coupling varactors.

This method implies a redundancy in the number of radiating elements and related control electronics. Another problem faced by current Holographic beam forming technology is the quantization of the phase shift, since the phase shift precision depends on the available phase discretization, which cannot be varied continuously. The maximum precision is limited by the number of radiating elements that can be fitted within the antenna array, and the cost therefore increases with desired phase control precision.

It is known to use optical RF beam forming networks, in particular fibre optic TTD systems, for phase control and distribution of signals within microwave phased array antenna systems. For example a fibre Bragg grating based TTD system is reported by A. Molony et al, “Fibre Bragg grating time delay control of phased array antennae”, Journal of Modern Optics, vol. 43, no. 5, pages 1017-1024, 1996, in which the wavelength of the optical carrier signal is tuned to be reflected from the appropriate Bragg grating within the delay line to apply the required time delay.

### SUMMARY

An aspect provides a communication network node comprising an antenna array, a plurality of photodiodes, an optical delay line and a plurality of optical splitters. The antenna array comprises a plurality of radiating elements. The photodiodes are connected to the radiating elements. The optical delay line is configured to receive an optical carrier signal modulated with an RF signal. The optical splitters are provided along the optical delay line. The optical splitters are configured to split off portions of the optical carrier signal to form a plurality of optical output signals and to deliver the optical output signals to the photodiodes. The photodiodes are configured to recover respective portions of the RF signal from the optical output signals and to deliver said portions of the RF signal to the radiating elements. The optical delay line is configured to time delay the optical carrier signal between optical splitters to thereby phase shift the RF signal.

The communication network node may enable management of the phase and amplitude of the signal at an array system to be performed via photonic technologies in a way that is more efficient and flexible then classic methods based on electronics. The communication network node may enable holographic beam forming in which the configuration of phase and amplitude of each radiating element is realized without the quantization effect suffered by known holographic beam forming systems and without the redundancy in the number of the radiating elements which these require, making the overall system more precise in the directionality and shape of the beams, less hungry for energy and more robust in the presence of hot spots due to dissipation near the radiating elements. By using an optical carrier, the reference wave may also be delivered over longer distances compared with the ones allowed by electrical lines that are affected by losses and poor signal integrity. In addition, photonics can help to reduce the phase noise on the RF signal. The optical delay line is fundamentally immune to electromagnetic interference from the radiated RF signal, being based on optical signals, and can deliver high frequency signals (e.g. 100 GHz) without the typical signal integrity issues that are found in electric delay lines.

In an embodiment, the optical delay line comprises tunable optical delay elements provided between the optical splitters. The tunable optical delay elements are reconfigurable such that time delays applied to the optical carrier signal between optical splitters are controllable, so that phase shifts in the RF signal resulting from the applied time delays are controllable. Advantageously, the phase of the RF signal transmitted at each radiating element can be changed by tuning the optical delay elements.

In an embodiment, the tunable optical delay elements comprise at least one of optical microring resonators, optical waveguide gratings or optical waveguide meshes.

In an embodiment, optical waveguide grating tunable optical delay elements comprise integrated grating-assisted contra directional couplers. This may enable flexible and fully reconfigurable time delay control, with a simple control system based on current signals sent to local micro-resistors on the photonic chip.

In an embodiment, the optical splitters are reconfigurable variable optical splitters such that optical powers of the optical output signals are controllable. This may enable the amount of optical power in each optical output signal sent to each photodiode to be regulated, and thus the amount of RF signal power transmitted by each radiating element may be regulated.

In an embodiment, the variable optical splitters are configured to split off different percentages of the optical carrier signal to form output optical signals of different optical powers. This may enable beam shaping of the composite RF signal formed from the RF signals transmitted by the radiating elements.

In an embodiment, the optical delay line and the optical splitters are fabricated as a silicon photonic integrated circuit.

In an embodiment, the optical carrier signal has a first wavelength, λ1. The communication network node further comprises an optical source, a wavelength selective reflector and optical time domain reflectometry apparatus. The optical source operable to output a second optical signal at a second wavelength, λ2, different to the first wavelength. The wavelength selective reflector is provided at an input end of the optical delay line and is configured to transmit the optical carrier signal into the optical delay line and to reflect the second optical signal. The optical time domain reflectometry apparatus operative to determine a time delay between output of a said second optical signal and receipt of said second optical signal reflected back from the wavelength selective reflector. The optical time domain reflectometry apparatus is further operative to determine a path length to the wavelength selective reflector based on said time delay. The distance from a central controller to the node may thus be determined.

In an embodiment, the communication network node further comprises a photonic radio frequency, RF, signal generator operable to generate the optical carrier signal modulated with an RF signal.

In an embodiment, the RF signal is an RF carrier signal modulated with an information signal.

Corresponding embodiments and advantages also apply to the communication network, the beam forming transmission system, the optical radio frequency, RF, holographic beam forming network and the method described below.

An aspect provides a communication network comprising a plurality of communication network nodes. Communication network nodes comprise an antenna array, a plurality of photodiodes, an optical delay line and a plurality of optical splitters. The photonic RF is operable to generate an optical carrier signal modulated with an RF signal. The antenna array comprises a plurality of radiating elements. The photodiodes are connected to the radiating elements. The optical delay line is configured to receive the optical carrier signal. The optical splitters are provided along the optical delay line. The optical splitters are configured to split off portions of the optical carrier signal to form a plurality of optical output signals and to deliver the optical output signals to the photodiodes. The photodiodes are configured to recover respective portions of the RF signal from the optical output signals and to deliver said portions of the RF signal to the radiating elements. The optical delay line is configured to time delay the optical carrier signal between variable optical splitters to thereby phase shift the RF signal.

An aspect provides a beam forming transmission system comprising a plurality of communication network nodes, a photonic radio frequency, RF, signal generator and an optical splitter. The communication network nodes comprise an antenna array, a plurality of photodiodes, an optical delay line and a plurality of optical splitters. The photonic RF is operable to generate an optical carrier signal modulated with an RF signal. The antenna array comprises a plurality of radiating elements. The photodiodes are connected to the radiating elements. The optical delay line is configured to receive the optical carrier signal. The optical splitters are provided along the optical delay line. The optical splitters are configured to split off portions of the optical carrier signal to form a plurality of optical output signals and to deliver the optical output signals to the photodiodes. The photodiodes are configured to recover respective portions of the RF signal from the optical output signals and to deliver said portions of the RF signal to the radiating elements. The optical delay line is configured to time delay the optical carrier signal between variable optical splitters to thereby phase shift the RF signal. The photonic RF signal generator is operable to generate an optical carrier signal modulated with an RF signal. The optical splitter is configured to split the optical carrier signal modulated with an RF signal into a plurality of portions and to direct the portions to the communication network nodes.

The beam forming transmission system may advantageously enable distributed multiple-input multiple-output, D-MIMO, transmission of RF signals.

In an embodiment, the beam forming transmission system further comprises a controller, the optical carrier signal has a first wavelength, λ1, and the communication network nodes further comprise an optical source, a wavelength selective reflector and optical time domain reflectometry apparatus. The optical source is operable to output a second optical signal at a second wavelength, λ2, different to the first wavelength. The wavelength selective reflector is provided at an input end of the optical delay line and is configured to transmit the optical carrier signal into the optical delay line and to reflect the second optical signal. The optical time domain reflectometry apparatus operative to determine a time delay between output of a said second optical signal and receipt of said second optical signal reflected back from the wavelength selective reflector. The optical time domain reflectometry apparatus is further operative to determine a path length to the wavelength selective reflector based on said time delay. The controller comprises a processor, interface circuitry and a memory. The memory contains instructions executable by said processor whereby the controller is operative to receive path lengths from the optical time domain reflectometry apparatus of the communication network nodes, and determine a combined field pattern for the communication network nodes based on the path lengths and on field patterns of the RF signals transmitted by the antenna arrays.

The beam forming transmission system advantageously enables synchronization among different signal distribution paths to take advantage of e.g. distributed MIMO scenarios, which is not possible in current Holographic beam forming solutions. In this case the RF signal may come from different antenna arrays that are located at different points in space, and the beam forming transmission system may enable the control of the interference pattern between the RF signal beams transmitted from different antenna arrays at different nodes. The beam forming transmission system may enable the exact path length to antenna arrays to be known with precision, enabling control of the interference pattern. This phase synchronization among multiple antenna arrays, may reduce a total interference pattern of the RF beams transmitted by the plurality of nodes. The beam forming transmission system may advantageously enable advantageously enable distributed multiple-input multiple-output, D-MIMO, transmission of RF signals from multiple antenna positions.

In an embodiment, the controller is further operative to determine an optimal combined field pattern and generate at least one control signal comprising instructions configured to cause the communication network nodes to configure the optical delay lines so that the field patterns of the RF signals transmitted by the antenna arrays form the optimal combined field pattern. This may enable phase synchronization among multiple antenna arrays, which may reduce a total interference pattern of the RF beams transmitted by the plurality of nodes. This may further enable the alignment of signals from different antenna arrays to shape the total radiation field pattern resulting from the contribution of each array. The beam forming transmission system may advantageously enable advantageously enable distributed multiple-input multiple-output, D-MIMO, transmission of RF signals from multiple antenna positions.

In an embodiment, the RF signal is an RF carrier signal modulated by an information signal. The optical signal thus carries both the RF carrier and the information, such as communications data, to be transmitted over the RF carrier.

An aspect provides an optical radio frequency, RF, holographic beam forming network comprising an optical delay line and a plurality of optical splitters. The optical delay line is configured to receive an optical carrier signal modulated with an RF signal. The optical splitters are provided along the optical delay line. The optical splitters are configured to split off portions of the optical carrier signal to form a plurality of optical output signals. The optical delay line is configured to time delay the optical carrier signal between variable optical splitters to thereby phase shift the RF signal.

In an embodiment, the optical delay line comprises tunable optical delay elements provided between the variable optical splitters. The tunable optical delay elements are reconfigurable such that time delays applied to the optical carrier signal between variable optical splitters are controllable, so that phase shifts in the RF signal resulting from the applied time delays are controllable.

In an embodiment, the tunable optical delay elements comprise at least one of optical microring resonators, optical waveguide gratings or optical waveguide meshes.

In an embodiment, optical waveguide grating tunable optical delay elements comprise integrated grating-assisted contra directional couplers.

In an embodiment, the optical splitters are reconfigurable variable optical splitters such that optical powers of the optical output signals are controllable.

In an embodiment, the variable optical splitters are configured to split off different percentages of the optical carrier signal to form output optical signals of different optical powers.

In an embodiment, the optical RF holographic beam forming network further comprises a wavelength selective reflector provided at an input end of the optical delay line. The wavelength selective reflector is configured to transmit an optical carrier signal at a first wavelength, λ1, into the optical delay line and to reflect a second optical signal at a second wavelength, λ2, different to the first wavelength.

In an embodiment, the optical RF holographic beam forming network is fabricated as a silicon photonic integrated circuit.

In an embodiment, the optical RF holographic beam forming network further comprises a photonic radio frequency, RF, signal generator operable to generate the optical carrier signal modulated with an RF signal.

In an embodiment, the RF signal is an RF carrier signal modulated by an information signal.

An aspect provides a method of transmitting a radio frequency, RF, signal in a communication network. The method comprises generating an optical carrier signal modulated with the RF signal and splitting off portions of the optical carrier signal to form a plurality of optical output signals. The optical carrier signal is time delayed between splitting off the portions to thereby phase shift the RF signal between splitting off the portions. The respective portions of the RF signal are recovered from the optical output signals and the respective portions of the RF signal are then transmitted.

Embodiments of the invention will now be described, by way of example only, with reference to the accompanying drawings.

### BRIEF DESCRIPTION OF THE DRAWINGS

FIGS. 1 to 6, 8 and 11 are block diagrams illustrating embodiments of a communication network node;

FIG. 7 is a block diagram illustrating an embodiment of a communication network;

FIGS. 9 and 10 are block diagrams illustrating embodiments of a beam forming transmission system;

FIGS. 12 to 14 are block diagrams illustrating embodiments of an optical RF holographic beam forming network; and

FIG. 15 is a flowchart illustrating an embodiment of method steps.

### DETAILED DESCRIPTION

The same reference numbers are used for corresponding features in different embodiments.

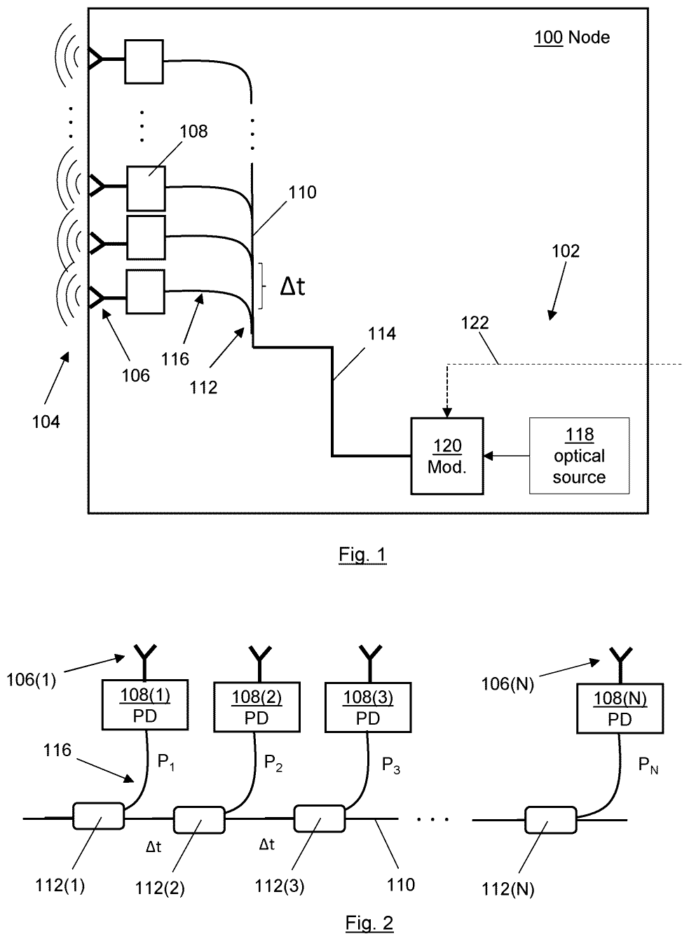

Referring to FIGS. 1 to 3, an embodiment provides a communication network node 100 comprising a photonic radio frequency, RF, signal generator 102, an antenna array 104, a plurality of photodiodes 108, an optical delay line 110 and a plurality of optical splitters 112.

The photonic RF signal generator is operable to generate an optical carrier signal that contains an RF signal to be transmitted by the antenna array. The photonic RF signal generator comprises an optical source 118 and an optical modulator 120. The optical source is operative to generate an optical carrier signal modulated with an RF carrier signal. The optical modulator is configured to receive an information signal 122 and to modulate the RF modulated optical carrier signal with the information signal, thus modulating the RF carrier signal with the information signal. The RF signal contained by the optical carrier signal is thus the RF carrier signal modulated with the information signal.

The optical source may comprise a laser source and local oscillator, as described in A. Malacarne et al, “Reconfigurable Low Phase Noise RF Carrier Generation up to W-band in Silicon Photonics Technology”, J. Lightwave Technol., 2022. Alternatively, the optical source may comprise two laser sources or a dual wavelength laser source, as described in G. Carpintero et al, “Microwave Photonic Integrated Circuits for Millimeter-Wave Wireless Communications”, J. Lightwave Technol., vol. 32. No. 20, Oct. 2014. Further alternatively, the optical source may comprise a mode locked laser or an optical oscillator, as described in P. Guelfi et al, “Generation of Highly Stable Microwave Signals Based on Regenerative Fiber Mode Locking Laser”, OSA Conference on Lasers and Electro-Optics (CLEO), 2010, paper JWA 47.

The antenna array comprises a plurality of radiating elements 106 (1-N). Each photodiode 108 (1-N) is connected to a respective radiating element.

The optical delay line is configured to receive the optical carrier signal modulated with the RF signal. This may be delivered to the optical delay line via a delivery waveguide or optical fibre 114.

The optical splitters 112 (1-N) are provided along the optical delay line. Each optical splitter is configured to split off a portion of the optical carrier signal to form a plurality of optical output signals, each having a respective power P(1-N). One output of each optical splitter is connected to the optical delay line, to continue to propagate the remaining power of the optical carrier signal along the optical delay line, and the other output of each optical splitter is connected to a respective photodiode via a respective drop waveguide 116, to deliver the optical output signals to the photodiodes.

The optical delay line is configured to time delay, Δt, the optical carrier signal between optical splitters. The optical delay line may be configured to add path length or to introduce delay in the group velocity of the optical carrier signal. The optical delay line therefore introduces a delay in the arrival time of the optical carrier signal at the different photodiodes. The time delay, Δt, is a fraction of a period of the RF signal, thus a corresponding phase shift is introduced in the RF signal. The photodiodes therefore receive the same RF signal, but with different phases, at a given time t.

By applying time delays to the optical carrier signal as it propagates from one optical splitter to the next, each output optical signal has a total time delay applied to it which is the sum of the time delays applied between each pair of optical splitters that it has traversed. In this way, different total time delays can be applied to output optical signals.

Each photodiode is configured to recover a respective portion of the RF signal from the optical output signal that it receives, and to deliver the recovered portion of the RF signal to the radiating element that it is connected to. The phase of the recovered portion of the RF signal, and thus of the RF signal transmitted by the radiating element, is determined by the total time delay that has been applied to the output optical signal received by the photodiode.

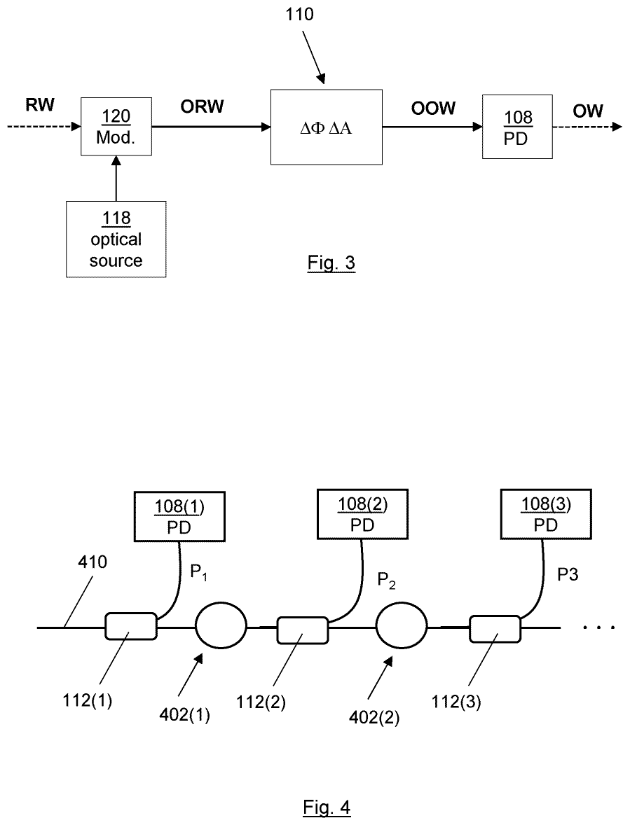

The node 100 thus performs optical RF holographic beam forming, as illustrated in FIG. 3. The optical modulator receives the RF signal (referred to in holographic beam forming as the ‘Reference wave’) and modulates the optical carrier signal with the RF signal. The optical carrier signal modulated by the RF signal may be referred to as an Optical Reference wave. The optical reference wave is controlled in amplitude and phase by the optical delay line to generate an Optical Object wave. Finally, the Optical Object wave is converted into an electrical signal by the photodiodes and the phase/amplitude controlled RF signal is transmitted by the radiating elements, to form what is referred to in holographic beam forming as the ‘Object wave’. The process of generation of the Object wave thus includes functions that are performed in the optical domain, which enables the node to exploit advantageous phase shifting techniques, as described above, and the general benefits of optical signals in terms of signal integrity and immunity to electro-magnetic interference.

In an embodiment, the optical delay line 110 and the optical splitters 112 are fabricated as a silicon photonic integrated circuit.

In an embodiment, illustrated in FIG. 4, the optical delay line 410 comprises tunable optical delay elements 402 provided between the optical splitters 112. The tunable optical delay elements are reconfigurable such that time delays applied to the optical carrier signal between optical splitters are controllable. The phase shifts in the RF signal resulting from the applied time delays are thus correspondingly controllable.

Use of tunable optical delay elements mitigates the problem experienced by existing RF Holographic beam forming of the quantization of the phase shift, which means that the phase shift precision is limited by the phase discretization, which cannot be varied continuously. The maximum phase shift precision, i.e. the minimum phase step, is limited by the number of radiating elements that can be fitted on the antenna board, and the cost of this solution increases with desired precision. The tunable optical delay elements enable continuously variable phase shift and avoid the need to activate only some of the radiating elements in order to obtain the desired phase shift.

In an embodiment, the tunable optical delay elements 402 comprise at least one of optical microring resonators, optical waveguide gratings or optical waveguide meshes. The time delay applied by these optical delay elements can be controlled with high precision. For example time delays of less than 1/100 ps are easily achievable. This means that a practically continuous phase control is achievable, even on very high frequency millimetre-wave signals. For example, for a 100 GHz signal (time period 10 ps) a phase control precision of less than 2π/1000 rad may be achieved.

The optical waveguide grating tunable optical delay elements may, for example, comprise integrated grating-assisted contra directional couplers, as described in Xu Wang, et al, “Tunable optical delay line based on integrated grating-assisted contradirectional couplers,” Photonics Research, volume 6, pages 880-886, 2018. This tunable delay line exploits the thermo-optic effect for tuning and the integrated grating-assisted contra-directional couplers are tuned by heating via micro-resistors provided on top of the photonic chip.

The time delay applied by the microring resonators may also be tuned via the thermos-optic effect, using heating elements.

The optical waveguide meshes comprise composite optical paths obtained by routing light in a mesh of optical waveguides, as described for example in D. Perez, et al, “Programmable true-time delay lines using integrated waveguide meshes,” Journal of Lightwave Technol. page 1, 2018. The path is set by variable couplers at each crossing, where light can be sent in one direction or the other. The total path length, and thus the total delay, corresponds to multiples of the length of the mesh cell.

In an embodiment, the optical splitters 112 are reconfigurable variable optical splitters. The percentage of the optical carrier signal that is split off by each variable optical splitter, to form the optical output signals, can be varied so that the optical power of the optical output signals is controllable, and thus the amplitude of the RF signal portions recovered by the photodiodes, and transmitted by the radiating elements, is controllable.

The reconfigurable variable optical splitters may, for example, be a Mach Zehnder Interferometer, a tunable directional coupler or a resonant coupler such as a ring resonator.

In an embodiment, the variable optical splitters 112 are configured to split off different percentages of the optical carrier signal to form output optical signals of different optical powers. The percentage of the optical carrier signal that is split off by each variable optical splitter, to form the optical output signals, can be varied so that the optical power of each optical output signals is independently controllable. Then, because of the different optical powers received by the photodiodes, the RF signal portions recovered by the photodiodes, and transmitted by the radiating elements, will have different amplitudes.

In an embodiment, the optical delay line 410 and the optical splitters 112 are fabricated as a silicon photonic integrated circuit.

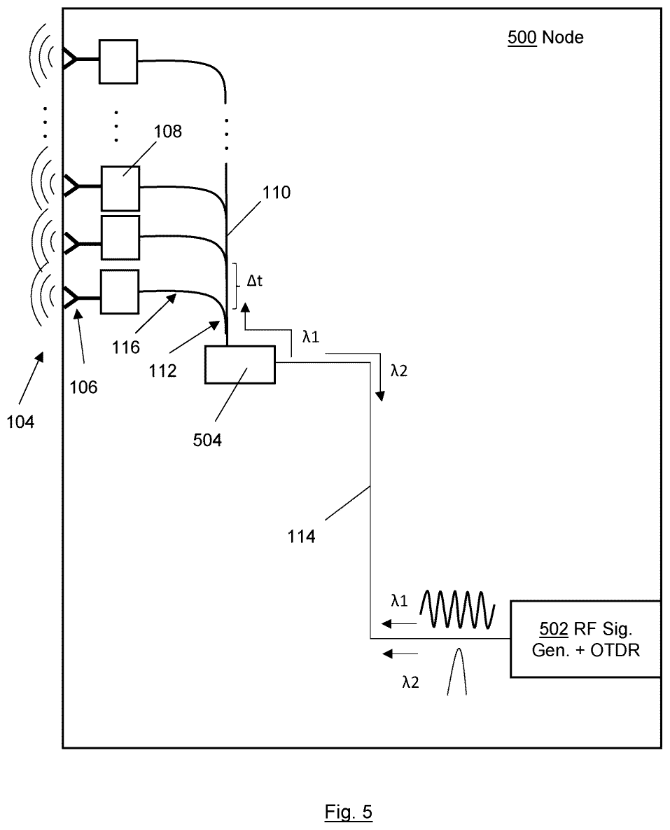

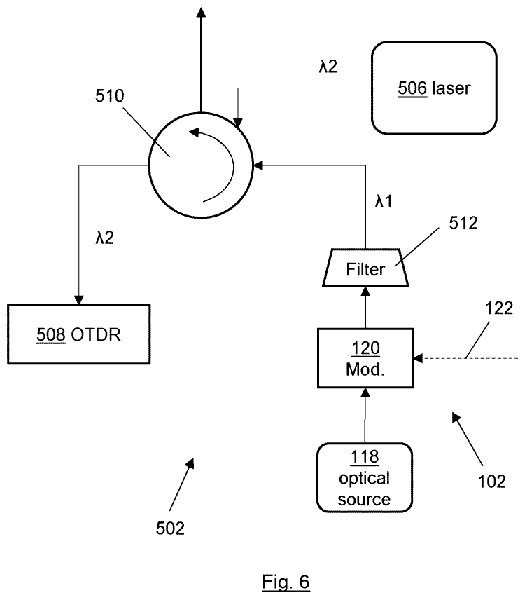

An embodiment provides a communication network node 500 as illustrated in FIGS. 5 and 6. In this embodiment the node further comprises a wavelength selective reflector 504, an optical source 506 and optical time domain reflectometry apparatus 508. The optical source 118 is configured to generate the optical carrier signal having a first wavelength, λ1.

The optical source 506 is operable to output a second optical signal at a second wavelength, λ2, different to the first wavelength.

The wavelength selective reflector 504 is provided at an input end of the optical delay line 110. The wavelength selective reflector is configured to transmit the optical carrier signal at λ1 into the optical delay line and to reflect the second optical signal at λ2.

The optical time domain reflectometry, OTDR, apparatus 508 is operative to determine a time delay between output of the second optical signal and receipt of the second optical signal reflected back from the wavelength selective reflector. Since the optical carrier signal is transmitted in optical waveguides and optical fibre from the RF signal generator 102 to the photodiodes 108, an optical measurement of the path length taken by the optical carrier signal to the optical delay line 110, using OTDR based on measurement of time delay between the output and reflected second optical signal.

The optical time domain reflectometry apparatus is further operative to determine a path length to the wavelength selective reflector based on the calculated time delay.

The optical circulator 510 allows the reflected second optical signal to reach the OTDR apparatus without interfering with the outgoing second optical signal. The optical filter 512 prevents any of the second optical signal reaching the RF signal generator 102.

In an embodiment, the wavelength selective reflector is a Bragg grating, which may be integrated in the delivery fibre 114, at the point where it is coupled to the optical delay line.

In an embodiment, the optical source 506 is a pulsed laser operable to output optical pulses at the second wavelength, λ2. The OTDR apparatus 508 is operative to measure the time delay from the output of a laser pulse by the optical source to reception of the optical pulse reflected back from the wavelength selective reflector. The measure of the delay between the outgoing and reflected pulses may be performed by correlating the amplitude variations of the outgoing pulse and the reflected pulse.

In an alternative embodiment, the optical source 506 is operable to output a modulated optical signal at the second wavelength, λ2. The second optical signal is modulated at a chosen frequency and the OTDR apparatus is operative to correlate the phase of the outgoing second optical signal and that of the second optical signal reflected back from the wavelength selective reflector. The modulation frequency may be adapted to the expected distance from the RF signal generation and OTDR apparatus 502 and the optical delay line 110.

Corresponding embodiments and advantages apply also to the optical radio frequency, RF, holographic beam forming network, the communication network and the method described below.

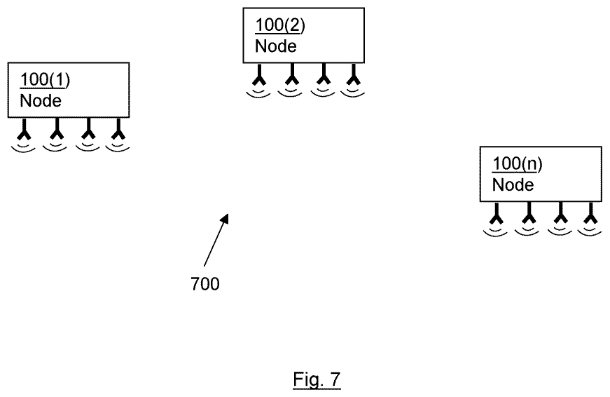

Referring to FIG. 7, an embodiment provides a communication network 700 comprising a plurality of communication network nodes 100.

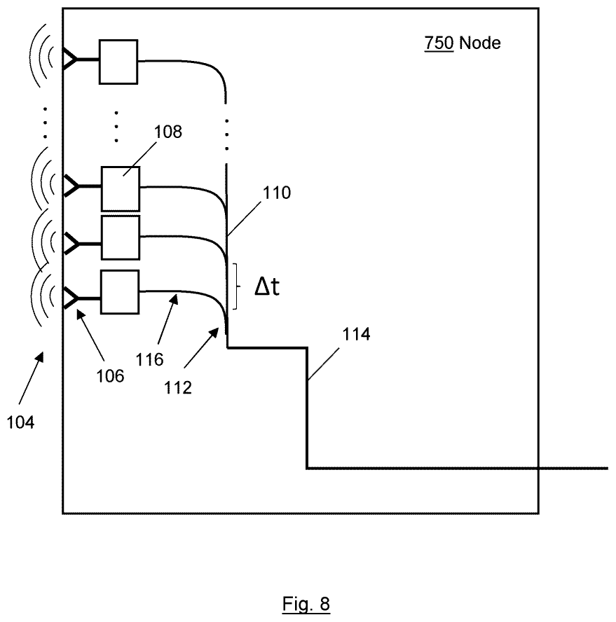

Referring to FIG. 8, an embodiment provides a communication network node 750 comprising a an antenna array 104, a plurality of photodiodes 108, an optical delay line 110 and a plurality of optical splitters 112.

The optical delay line is configured to receive an optical carrier signal modulated with an RF signal, via a delivery waveguide or optical fibre 114. The RF signal is an RF carrier signal modulated with an information signal.

The antenna array comprises a plurality of radiating elements 106 (1-N). Each photodiode 108 (1-N) is connected to a respective radiating element.

The optical splitters 112 (1-N) are provided along the optical delay line. Each optical splitter is configured to split off a portion of the optical carrier signal to form a plurality of optical output signals, each having a respective power P(1-N). One output of each optical splitter is connected to the optical delay line, to continue to propagate the remaining power of the optical carrier signal along the optical delay line, and the other output of each optical splitter is connected to a respective photodiode via a respective drop waveguide 116, to deliver the optical output signals to the photodiodes.

The optical delay line is configured to time delay, Δt, the optical carrier signal between optical splitters. The optical delay line may be configured to add path length or to introduce delay in the group velocity of the optical carrier signal. The optical delay line therefore introduces a delay in the arrival time of the optical carrier signal at the different photodiodes. The time delay, Δt, is a fraction of a period of the RF signal, thus a corresponding phase shift is introduced in the RF signal. The photodiodes therefore receive the same RF signal, but with different phases, at a given time t.

Each photodiode is configured to recover a respective portion of the RF signal from the optical output signal that it receives, and to deliver the recovered portion of the RF signal to the radiating element that it is connected to. The phase of the recovered portion of the RF signal, and thus of the RF signal transmitted by the radiating element, is determined by the total time delay that has been applied to the output optical signal received by the photodiode.

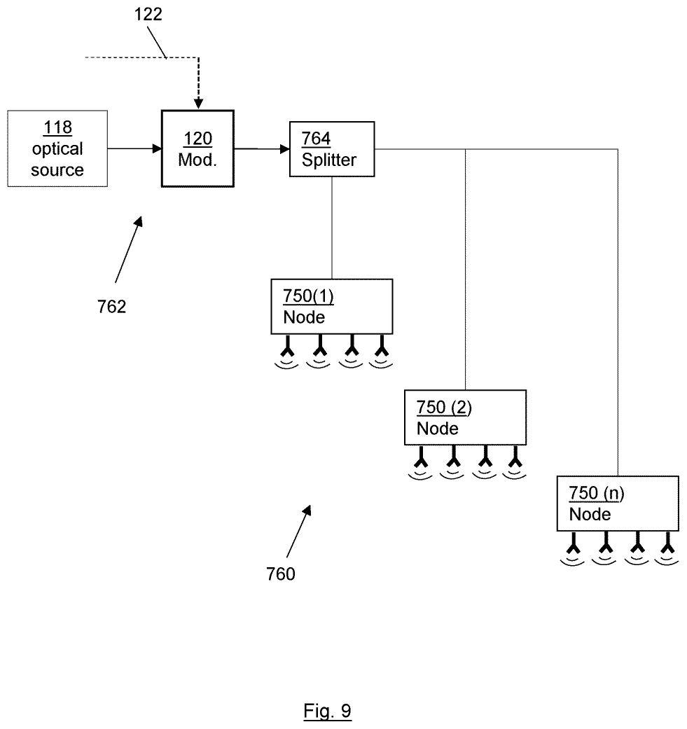

Referring to FIG. 9, an embodiment provides a beam forming transmission system 760 comprising a plurality of communication network nodes 750, a photonic RF signal generator, 762 and an optical splitter 764.

The photonic RF signal generator is operable to generate an optical carrier signal modulated with an RF signal. The photonic RF signal generator comprises an optical source 118 and an optical modulator 120. The optical source is operative to generate an optical carrier signal modulated with an RF carrier signal. The optical modulator is configured to receive an information signal 122 and to modulate the RF modulated optical carrier signal with the information signal, thus modulating the RF carrier signal with the information signal. The RF signal contained by the optical carrier signal is thus the RF carrier signal modulated with the information signal.

The optical splitter is configured to split the optical carrier signal modulated with an RF signal into a plurality of portions and to direct the portions to the communication network nodes 750.

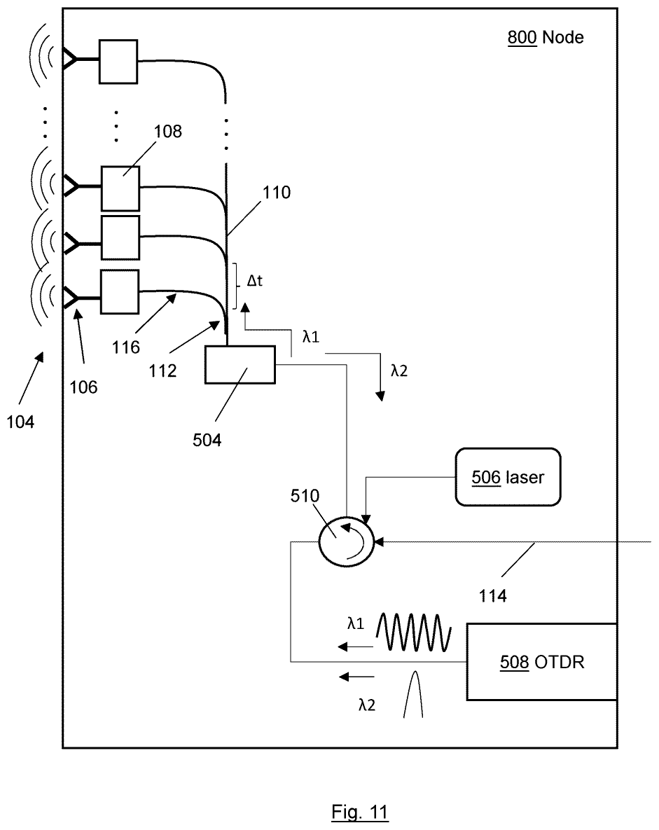

Referring to FIG. 11, an embodiment provides a communication network node 800 comprising a an antenna array 104, a plurality of photodiodes 108, an optical delay line 110 and a plurality of optical splitters 112, as described above with reference to FIG. 8.

The node 800 of this embodiment additionally comprises a wavelength selective reflector 504, an optical source 506 and optical time domain reflectometry apparatus 508.

The optical delay line 110 is configured to receive an optical carrier signal modulated with an RF signal, the optical carrier signal having a first wavelength, λ1, input via an input optical fibre 114 and an optical circulator 510. The optical source 506 is operable to output a second optical signal at a second wavelength, λ2, different to the first wavelength.

The wavelength selective reflector 504 is provided at an input end of the optical delay line 110. The wavelength selective reflector is configured to transmit the optical carrier signal at λ1 into the optical delay line and to reflect the second optical signal at λ2.

The optical time domain reflectometry, OTDR, apparatus 508 is operative to determine a time delay between output of the second optical signal and receipt of the second optical signal reflected back from the wavelength selective reflector. Since the optical carrier signal is transmitted in optical waveguides and optical fibre from the RF signal generator 102 to the photodiodes 108, an optical measurement of the path length taken by the optical carrier signal to the optical delay line 110, using OTDR based on measurement of time delay between the output and reflected second optical signal.

The optical time domain reflectometry apparatus is further operative to determine a path length to the wavelength selective reflector based on the calculated time delay.

The optical circulator 510 allows the reflected second optical signal to reach the OTDR apparatus without interfering with the outgoing second optical signal. The optical filter 512 prevents any of the second optical signal reaching the RF signal generator 102.

In an embodiment, the wavelength selective reflector is a Bragg grating, which may be integrated in the delivery fibre 114, at the point where it is coupled to the optical delay line.

In an embodiment, the optical source 506 is a pulsed laser operable to output optical pulses at the second wavelength, λ2. The OTDR apparatus 508 is operative to measure the time delay from the output of a laser pulse by the optical source to reception of the optical pulse reflected back from the wavelength selective reflector. The measure of the delay between the outgoing and reflected pulses may be performed by correlating the amplitude variations of the outgoing pulse and the reflected pulse.

In an alternative embodiment, the optical source 506 is operable to output a modulated optical signal at the second wavelength, λ2. The second optical signal is modulated at a chosen frequency and the OTDR apparatus is operative to correlate the phase of the outgoing second optical signal and that of the second optical signal reflected back from the wavelength selective reflector. The modulation frequency may be adapted to the expected distance from the RF signal generation and OTDR apparatus 502 and the optical delay line 110.

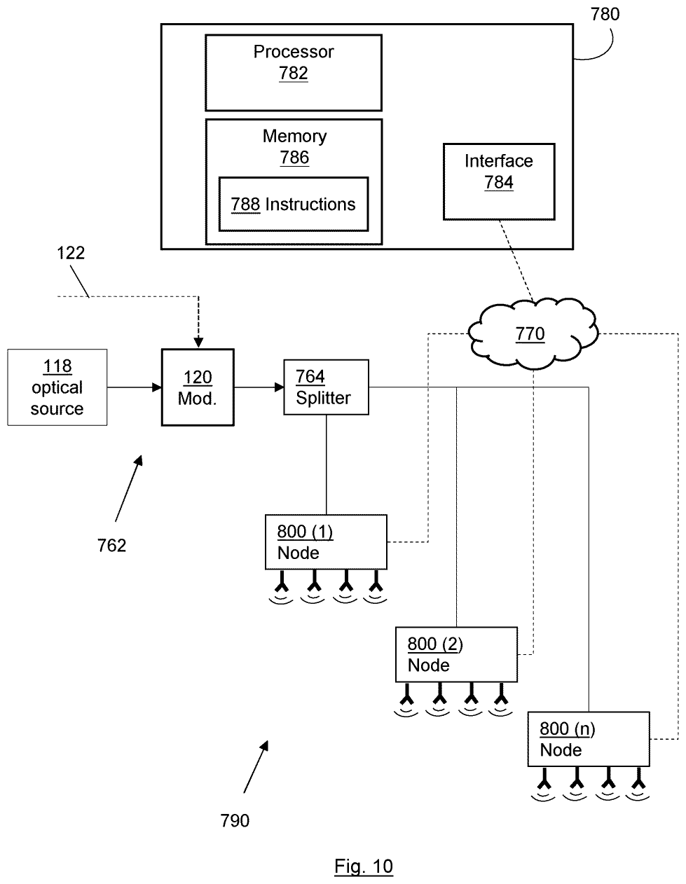

Referring to FIG. 10, an embodiment provides a beam forming transmission system 790 comprising a plurality of communication network nodes 800, a photonic RF signal generator, 762, and an optical splitter 764, as described above. The system 790 additionally comprises a controller 780. The controller 780 may be located remote from the nodes 800 and connected to the nodes 800 via network infrastructure 770. The communication network 790 may thus be operative to configure the network nodes remotely.

The controller 780 comprises a processor 782, interface circuitry 784 and a memory 786. The memory contains instructions 788 executable by the processor whereby the controller is operative to determine respective path lengths to the antenna arrays 104 of the nodes 800, and to determine a combined field pattern for the communication network nodes. The combined field pattern is based on the path lengths to the antenna arrays and on field patterns of the RF signals transmitted by the antenna arrays.

In an embodiment, the controller 780 is further operative to determine an optimal combined field pattern. The controller is also operative to generate at least one control signal comprising instructions configured to cause the communication network nodes to configure the optical delay lines so that the field patterns of the RF signals transmitted by the antenna arrays form the optimal combined field pattern.

The measurement of the path lengths by the OTDR apparatus at each node enables the controller to know the exact path length to an antenna array of a node. The controller is operative to determine the time delay between the optical carrier signal (and thus of the RF signal) arriving at the antenna array of a first node 500 (1) and arriving at the antenna array of a second node 500 (2), based on the path lengths to the two nodes. The controller is thus able to calculate the combined field pattern generated by the multiple antenna arrays at the nodes and to configure the emitted fields in a way that optimizes the combined field distribution. This may enable unwanted interference between the RF signal transmitted by the nodes 500 within the network to be mitigated or avoided.

Knowledge of the path lengths also enables synchronization of the RF signals transmitted by antenna arrays 104 of the nodes 500, thus the communication network 750 may be used for distributed MIMO applications. The antenna arrays transmit replicas of the same RF signal in a beamforming scheme, with different amplitude/phase/position of the array.

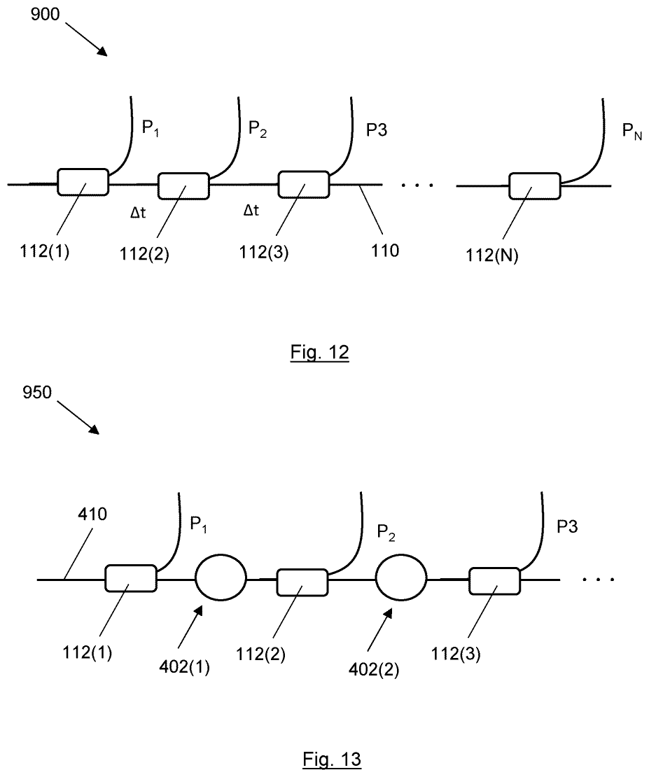

Referring to FIG. 12 an embodiment provides an optical radio frequency, RF, holographic beam forming network 900 comprising an optical delay line 110 and a plurality of optical splitters 112.

The optical delay line is configured to receive an optical carrier signal modulated with an RF signal.

The optical splitters 112 (1-N) are provided along the optical delay line. Each optical splitter is configured to split off a portion of the optical carrier signal to form a plurality of optical output signals, each having a respective power P(1-N). One output of each optical splitter is connected to the optical delay line, to continue to propagate the remaining power of the optical carrier signal along the optical delay line, and the other output of each optical splitter delivers the optical output signal to a respective photodiode.

The optical delay line is configured to time delay, Δt, the optical carrier signal between optical splitters. The optical delay line may be configured to add path length or to introduce delay in the group velocity of the optical carrier signal. The optical delay line therefore introduces a delay in the arrival time of the optical carrier signal at the different photodiodes. The time delay, Δt, is a fraction of a period of the RF signal, thus a corresponding phase shift is introduced in the RF signal. Photodiodes connected to the optical RF holographic beam forming network will therefore receive the same RF signal, but with different phases, at a given time t.

By applying time delays to the optical carrier signal as it propagates from one optical splitter to the next, each output optical signal has a total time delay applied to it which is the sum of the time delays applied between each pair of optical splitters that it has traversed. In this way, different total time delays can be applied to output optical signals.

In an embodiment, the optical RF holographic beam forming network 800 is fabricated as a silicon photonic integrated circuit.

Referring to FIG. 13, an embodiment provides an optical RF holographic beam forming network 950 comprising an optical delay line 410 and a plurality of optical splitters 112. The optical delay line 410 comprises tunable optical delay elements 402 provided between the optical splitters 112. The tunable optical delay elements are reconfigurable such that time delays applied to the optical carrier signal between optical splitters are controllable. The phase shifts in the RF signal resulting from the applied time delays are thus correspondingly controllable.

In an embodiment, the tunable optical delay elements 402 comprise at least one of optical microring resonators, optical waveguide gratings or optical waveguide meshes.

The optical waveguide grating tunable optical delay elements may, for example, comprise integrated grating-assisted contra directional couplers, as described in Xu Wang, et al, “Tunable optical delay line based on integrated grating-assisted contradirectional couplers,” Photonics Research, volume 6, pages 880-886, 2018.

The time delay applied by the microring resonators may also be tuned via the thermos-optic effect, using heating elements.

The optical waveguide meshes comprise composite optical paths obtained by routing light in a mesh of optical waveguides, as described for example in D. Perez, et al, “Programmable true-time delay lines using integrated waveguide meshes,” Journal of Lightwave Technol. page 1, 2018.

In an embodiment, the optical splitters 112 are reconfigurable variable optical splitters. The percentage of the optical carrier signal that is split off by each variable optical splitter, to form the optical output signals, can be varied so that the optical power of the optical output signals is controllable, and thus the amplitude of the RF signal portions carried by the optical output signals is controllable.

The reconfigurable variable optical splitters may, for example, be a Mach Zehnder Interferometer, a tunable directional coupler or a resonant coupler such as a ring resonator.

In an embodiment, the variable optical splitters 112 are configured to split off different percentages of the optical carrier signal to form output optical signals of different optical powers. The percentage of the optical carrier signal that is split off by each variable optical splitter, to form the optical output signals, can be varied so that the optical power of each optical output signals is independently controllable.

In an embodiment, the optical RF holographic beam forming network 900 is fabricated as a silicon photonic integrated circuit.

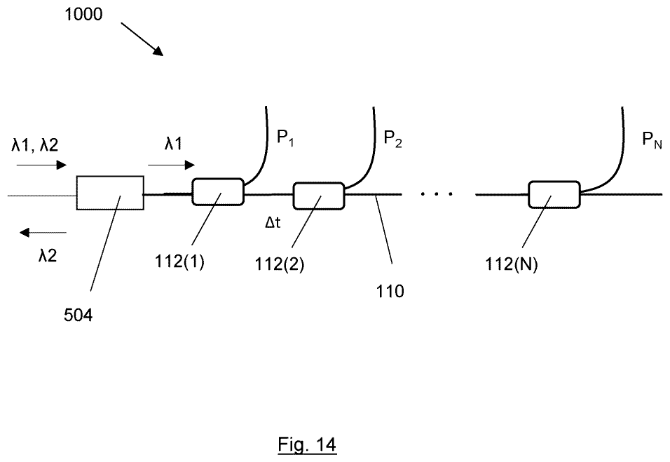

In an embodiment, illustrated in FIG. 14, the optical RF holographic beam forming network further comprises a wavelength selective reflector 504. The wavelength selective reflector is provided at an input end of the optical delay line 110. The wavelength selective reflector is configured to transmit an optical carrier signal at a first wavelength, λ1, into the optical delay line and to reflect a second optical signal at a second wavelength, λ2, different to the first wavelength.

In an embodiment, the optical RF holographic beam forming network 1000 is fabricated as a silicon photonic integrated circuit.

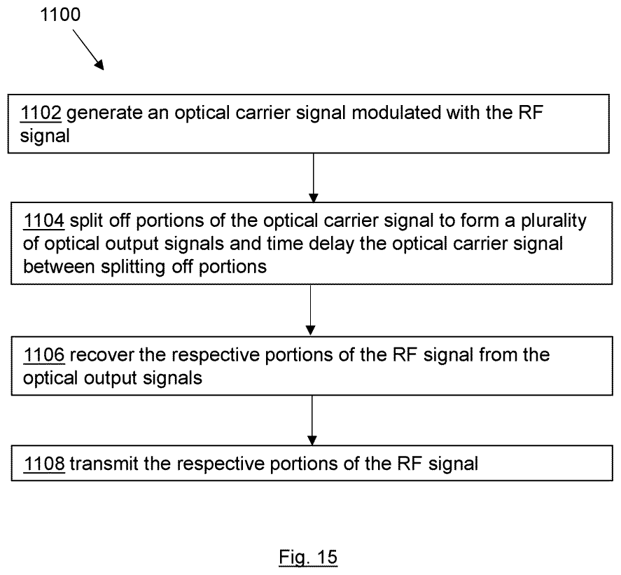

Referring to FIG. 15, an embodiment provides a method 1100 of transmitting a radio frequency, RF, signal in a communication network.

The method comprises generating 1102 an optical carrier signal modulated with the RF signal. Portions of the optical carrier signal are split off 1104 to form a plurality of optical output signals. The optical carrier signal is time delayed 1104 between splitting off the portions to thereby phase shift the RF signal between splitting off the portions. The respective portions of the RF signal carried by the optical output signals are recovered 1106 from the optical output signals and the respective portions of the RF signal are then transmitted 1108.

1. A communication network node comprising:
an antenna array comprising a plurality of radiating elements;
a plurality of photodiodes connected to the radiating elements;
an optical delay line configured to receive an optical carrier signal modulated with an RF signal; and
a plurality of optical splitters provided along the optical delay line, the optical splitters configured to split off portions of the optical carrier signal to form a plurality of optical output signals and to deliver the optical output signals to the photodiodes,
wherein the photodiodes are configured to recover respective portions of the RF signal from the optical output signals and to deliver said portions of the RF signal to the radiating elements, and wherein the optical delay line is configured to time delay the optical carrier signal between optical splitters to thereby phase shift the RF signal.

2. (canceled)

3. (canceled)

4. The communication network node of claim 1, wherein:
the optical delay line comprises tunable optical delay elements provided between the optical splitters, the tunable optical delay elements are reconfigurable such that time delays applied to the optical carrier signal between optical splitters are controllable, so that phase shifts in the RF signal resulting from the applied time delays are controllable;
the tunable optical delay elements comprise at least one of optical microring resonators, optical waveguide gratings or optical waveguide meshes; and
optical waveguide grating tunable optical delay elements comprise integrated grating-assisted contra directional couplers.

5. The communication network node of claim 4, wherein the optical splitters are reconfigurable variable optical splitters such that optical powers of the optical output signals are controllable.

6. The communication network node of claim 5, wherein the variable optical splitters are configured to split off different percentages of the optical carrier signal to form output optical signals of different optical powers.

7. The communication network node of claim 6, wherein the optical delay line and the optical splitters are fabricated as a silicon photonic integrated circuit.

8. The communication network node of claim 1,
wherein the optical carrier signal has a first wavelength, λ1, and further comprising:
an optical source operable to output a second optical signal at a second wavelength, λ2, different to the first wavelength;
a wavelength selective reflector provided at an input end of the optical delay line and configured to transmit the optical carrier signal into the optical delay line and to reflect the second optical signal; and
optical time domain reflectometry apparatus operative to:
determine a time delay between output of a said second optical signal and receipt of said second optical signal reflected back from the wavelength selective reflector; and
determine a path length to the wavelength selective reflector based on said time delay.

9. The communication network node of claim 1, further comprising a photonic radio frequency, RF, signal generator operable to generate the optical carrier signal modulated with an RF signal.

10. The communication network node of claim any one of claim 1, wherein the RF signal is an RF carrier signal modulated with an information signal.

11. (canceled)

12. A beam forming transmission system, comprising:
a plurality of communication network nodes according to claim 1;
a photonic radio frequency, RF, signal generator operable to generate an optical carrier signal modulated with an RF signal; and
an optical splitter configured to split the optical carrier signal modulated with an RF signal into a plurality of portions and to direct the portions to the communication network nodes.

13. The beam forming transmission system of claim 12, comprising a plurality of communication network nodes 8; and
a controller comprising a processor, interface circuitry and a memory, said memory containing instructions executable by said processor whereby the controller is operative to:
receive path lengths from an optical time domain reflectometry apparatus of the communication network nodes; and
determine a combined field pattern for the communication network nodes based on the path lengths and on field patterns of the RF signals transmitted by the antenna arrays.

14. The beam forming transmission system of claim 13, wherein the controller is further operative to:
determine an optimal combined field pattern; and
generate at least one control signal comprising instructions configured to cause the communication network nodes to configure the optical delay lines so that the field patterns of the RF signals transmitted by the antenna arrays form the optimal combined field pattern.

15. An optical radio frequency, RF, holographic beam forming network comprising;
an optical delay line configured to receive an optical carrier signal modulated with an RF signal; and
a plurality of optical splitters provided along the optical delay line, the optical splitters configured to split off portions of the optical carrier signal to form a plurality of optical output signals, and wherein the optical delay line is configured to time delay the optical carrier signal between variable optical splitters to thereby phase shift the RF signal.

16. The optical RF holographic beam forming network of claim 15, wherein the optical delay line comprises tunable optical delay elements provided between the variable optical splitters, the tunable optical delay elements are reconfigurable such that time delays applied to the optical carrier signal between variable optical splitters are controllable, so that phase shifts in the RF signal resulting from the applied time delays are controllable.

17. The optical RF holographic beam forming network of claim 16, wherein the tunable optical delay elements comprise at least one of optical microring resonators, optical waveguide gratings or optical waveguide meshes.

18. The optical RF holographic beam forming network of claim 17, wherein optical waveguide grating tunable optical delay elements comprise integrated grating-assisted contra directional couplers.

19. The optical RF holographic beam forming network of claim 15, wherein the optical splitters are reconfigurable variable optical splitters such that optical powers of the optical output signals are controllable.

20. The optical RF holographic beam forming network of claim 19, wherein the variable optical splitters are configured to split off different percentages of the optical carrier signal to form output optical signals of different optical powers.

21. The optical RF holographic beam forming network of claim 15, further comprising a wavelength selective reflector provided at an input end of the optical delay line and configured to transmit an optical carrier signal at a first wavelength, λ1, into the optical delay line and to reflect a second optical signal at a second wavelength, λ2, different to the first wavelength.

22. The optical RF holographic beam forming network of claim 15, wherein the optical RF holographic beam forming network is fabricated as a silicon photonic integrated circuit.

23. The optical RF holographic beam forming network of claim 15, further comprising a photonic radio frequency, RF, signal generator operable to generate the optical carrier signal modulated with an RF signal.

24. (canceled)
